(19) United States
(12) Patent Application Publication
(10) Pub. No.: US 2012/0038501 A1
(43) Pub. Date: Feb. 16, 2012

(54) SELF-CONFIGURING UNIVERSAL ACCESS TRANSCEIVER

(75) Inventors: Christopher E.P. Schulte, Independence, OR (US); Thomas L. Mosher, Salem, OR (US)

(73) Assignee: GARMIN INTERNATIONAL, INC., Olathe, KS (US)

(21) Appl. No.: 13/282,865

(22) Filed: Oct. 27, 2011

Related U.S. Application Data
(63) Continuation-in-part of application No. 12/642,458, filed on Dec. 18, 2009.
(60) Provisional application No. 61/409,184, filed on Nov. 2, 2010.

(51) Int. Cl. G01S 13/74

(52) U.S. Cl. 342/30

(57) ABSTRACT

Techniques are described that allow information to be acquired by an ADS-B system of an aircraft without the installation of ADS-B dedicated flight crew controls or wired data interfaces in the aircraft. In one or more implementations, a receiver is associated with the ADS-B system in the aircraft. The receiver is configured to receive reply transmissions from a transponder of the aircraft, such as a Mode A/C or Mode S radar, or the like. A transmitter may also be associated with the ADS-B system to transmit an interrogation to the transponder of the aircraft that is configured to cause the transponder of the aircraft to transmit the reply transmission. Information used by the ADS-B system is extracted from the received reply transmissions and furnished to the ADS-B transceiver for broadcast over the ADS-B data link.

### CROSS-REFERENCE TO RELATED APPLICATIONS

The present application claims the benefit of 35 U.S.C. §119(e) of U.S. Provisional Application Ser. No. 61/409,184, filed Nov. 2, 2010, and titled “SELF-CONFIGURING UNIVERSAL ACCESS TRANSCEIVER,” and also is a continuation-in-part of, and claims the benefit of, co-pending U.S. patent application Ser. No. 12/642,458, filed Dec. 18, 2009, and titled “SELF-CONFIGURING ADS-B SYSTEM”. These applications are herein incorporated by reference in their entirety.

### BACKGROUND

Automatic Dependent Surveillance-Broadcast (ADS-B) is a cooperative surveillance technique used for air traffic control and related applications. ADS-B-equipped aircraft determine their position using a Global Navigation Satellite System (GNSS) such as the United States Global Positioning System (GPS), or other position-determining equipment. The determined position of the aircraft is then combined with other data such as the type of aircraft, the speed of the aircraft, the aircraft's flight number, and whether the aircraft is turning, climbing, or descending and broadcast from the aircraft. Other ADS-B transceivers integrated into the air traffic control system or installed aboard other aircraft use the broadcast information, which is periodically updated, to provide users with an accurate depiction of real-time aviation traffic, both in the air and on the ground.

### SUMMARY

Techniques are described that allow information to be acquired by an ADS-B system of an aircraft without the installation of ADS-B dedicated flight crew controls (i.e. control panel) or wired data interfaces in the aircraft. In one or more implementations, a receiver is associated with the ADS-B system (e.g., with a Universal Access Transceiver (UAT) of an ADS-B system) in the aircraft. The receiver is configured to receive reply transmissions from a transponder of the aircraft, such as a Mode A/C or Mode S radar transponder, or the like. A transmitter may also be associated with the ADS-B system (e.g., with the UAT) to wirelessly transmit an interrogation to the transponder of the aircraft that is configured to cause the transponder of the aircraft to transmit the reply transmission. Information used by the ADS-B system is extracted from the received reply transmissions and furnished to the ADS-B transceiver for broadcast over the ADS-B data link.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that includes an aircraft which employs an ADS-B system having a receiver, configured to receive reply transmissions from a transponder of the aircraft and/or an optional transponder interrogation transmitter.

FIG. 2 is an illustration further depicting the ADS-B system and the transponder of the aircraft shown in the example environment of FIG. 1.

FIG. 3 is an illustration depicting the ADS-B system and the transponder of the aircraft shown in the example environment of FIG. 1, wherein the ADS-B transceiver is shown as being implemented as a Universal Access Transceiver (UAT) having a transmitter configured to interrogate the transponder of the aircraft and a receiver configured to receive reply transmissions from the transponder.

FIG. 4 is a flow diagram depicting a procedure in an example implementation in which information is acquired by an ADS-B system equipped with a receiver (and transmitter) configured to receive reply transmissions from a transponder of the aircraft.

### DETAILED DESCRIPTION

Overview

ADS-B equipped aircraft automatically broadcast information, such as aircraft position and velocity, Mode 3/A “Squawk” code, IDENT identification, the aircraft's altitude, and so on. When ADS-B is added to an aircraft, control of the ADS-B to provide at least some of this information may be accomplished via manual input on a control panel by the flight crew (e.g., the pilot, the co-pilot, or the like) or via a wired data interface to other aircraft avionics such as an MFD (Multi Function Display) or a radar transponder. In instances where manual input is used for control of the ADS-B, such as when the ADS-B transceiver is mounted in the aircraft's instrument panel, the flight crew must enter the information via controls such as knobs, switches, and the like, when changes to the information occur. This manual input of information may include duplicate data to that which is entered for the radar transponder and adds to the workload of the flight crew. In instances where the ADS-B is controlled via a wired data interface, such as an MFD or radar transponder the controlling avionics are pre-configured to support the wired data interface. Thus, aircraft having avionics that do not support such a wired data interface may require retrofit to support an ADS-B installation.

Accordingly, techniques are described that allow information to be furnished to an ADS-B transceiver of an aircraft without the installation of ADS-B dedicated flight crew controls and/or wired data interfaces with other avionics of the aircraft. In one or more implementations, a self-configuring ADS-B system installed within an aircraft is provided with a receiver. For instance, the ADS-B system may comprise a UAT system that includes an associated 1090 MHz receiver. The receiver is configured to receive reply transmissions from a transponder, such as a Mode A/C or Mode S radar transponder, or the like, of the aircraft (e.g., 1090 MHz reply codes). The ADS-B system (e.g., the UAT) may further include a transmitter such as a 1030 MHz transmitter to wirelessly transmit an interrogation to the transponder (e.g., a Mode A/C or Mode S radar transponder, or the like) of the aircraft that is configured to cause the transponder of the aircraft to transmit the reply transmission. Information that is used by the ADS-B system is extracted from the received reply transmission and furnished to the ADS-B system to be included in the data broadcast over the ADS-B data link. In embodiments, the information extracted from the reply transmissions may be configured (e.g., formatted) for broadcast by the ADS-B system.

The ADS-B system may thus employ a multi-mode/multi-channel radio transceiver or separate radio transceivers to detect the reply codes transmitted by a transponder of the aircraft. The ADS-B system may further employ a transmitter that interrogates the aircraft's transponder, via active wireless interrogation. In this manner, self-synchronization of information such as the aircraft's Mode 3/A Code (e.g., “squawk code”) shared by the aircraft's ADS-B system (e.g., via a Universal Access Transceiver (UAT) of the system) and transponder (e.g., a Mode A/C or Mode S transponder) may be provided via radio frequency (RF) interception of the transponder's natural replies to interrogations.

In the following discussion, an example aircraft environment employing an ADS-B system is first described. Example functionality is then described that may be implemented by the ADS-B system in the exemplary environment to acquire information from the radar transponder of the aircraft, as well as in other environments without departing from the spirit and scope thereof.

Example Environment

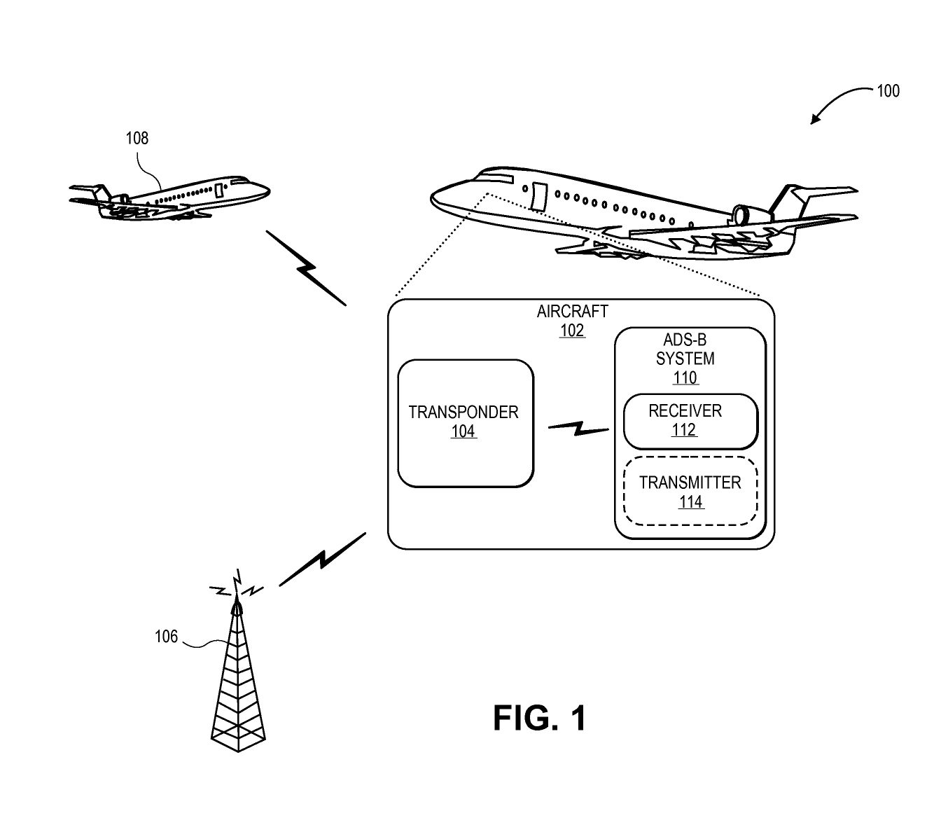

FIG. 1 illustrates an environment 100 in an example implementation that is operable to furnish information to an ADS-B system within an aircraft without the installation of ADS-B dedicated flight crew controls or a wired data interface to other avionics in the aircraft. The illustrated environment 100 comprises an aircraft 102 equipped with a transponder 104, which may be a radar transponder, such as a Mode A/C or Mode S transponder, or the like. Upon receipt of a radio frequency interrogation from an interrogation source, such as an air traffic control ground station 106, another aircraft 108, or the like, the transponder 104 is configured to transmit a reply transmission containing information about the aircraft 102. The information transmitted by the transponder 104 may be used by the interrogation source (e.g., air traffic control ground station 106 or aircraft 108) to assist in identifying and tracking the aircraft 102.

In one implementation, the transponder 104 may comprise a radar transponder of a Traffic Collision Avoidance System (TCAS). When interrogated by an air traffic control ground station 106 or the active traffic detection system (TAS/TCAD/TCAS) of another aircraft (e.g., aircraft 108), the transponder 104 may transmit a Mode A, a Mode C, or a Mode S reply transmission. These reply transmissions include a variety of information about the aircraft 102, including, but not limited to: an assigned Mode 3/A “squawk” code for the aircraft 102, the IDENT indication for the aircraft 102, the aircraft's altitude, and the like.

As shown in FIG. 1, the aircraft 102 is equipped with an ADS-B system 110. The ADS-B system 110 periodically broadcasts the position of the aircraft 102 determined from a position-determining system such as a Global Navigation Satellite System (GNSS) receiver, or the like over an ADS-B data link to air traffic control ground stations 106 and/or other aircraft 108. The ADS-B system 110 may further broadcast other relevant information about the aircraft 102 over the data link.

The ADS-B system 110 is configured to self-synchronize with the aircraft's transponder 104, extracting information from reply transmissions of the transponder 104 for inclusion in the data broadcast by the ADS-B system 110 over the ADS-B data link. As shown, the ADS-B system 110 may include a receiver 112 that is configured to receive reply transmissions from the transponder 104 that are transmitted when the transponder 104 is interrogated. Information is extracted from the received reply transmissions for inclusion in the data broadcast by the ADS-B system 110 over the ADS-B data link. In this manner, the ADS-B system 110 may remain physically independent of (e.g., physically separated from) the transponder 104 and other aircraft avionics. Thus, information utilized by the ADS-B system 110 installed within the aircraft 102 may be acquired without the installation of ADS-B dedicated flight crew controls and/or a wired data interface to the transponder 104 or other avionics in the aircraft 102.

The ADS-B system 110 may employ passive reception of transponder reply transmissions. In such implementations, the receiver 112 is configured to receive reply transmissions of the transponder 104 that are transmitted in response to interrogation of the transponder 104 by an interrogation source external to the aircraft 102 (e.g., a ground station 106, another aircraft 108, and so forth).

The ADS-B system 110 may also employ active interrogation of the transponder to cause the transponder to broadcast reply transmissions. In such implementations, the ADS-B system 110 may further include a transmitter 114 configured to wirelessly transmit interrogations to the transponder 104 to cause the transponder 104 to transmit a reply transmission that may be received by the receiver 112. The receiver 112 is configured to receive the reply transmissions provided by the transponder in reply to the interrogations sent by the transmitter 114.

In implementations employing a transmitter 114 for active wireless interrogation of the transponder 104, it is contemplated that the ADS-B system 110 may continue to employ passive reception. Thus, the receiver 112 may further be configured to receive reply transmissions from the transponder 104 that are transmitted in response to interrogations from external interrogation sources. For instance, under many circumstances, the transponder 104 may be interrogated by external interrogation sources (e.g., a ground station 106, another aircraft 108, and so forth) during normal operation of the aircraft 102 to an extent that renders active interrogation of the transponder 104 by the transmitter 114 unnecessary. Consequently, active interrogation of the transponder 104 may be employed when external interrogation of the transponder 104 causes insufficient reply transmissions to be transmitted. However, it is also contemplated that in instances where active interrogation is employed, reply transmissions from the transponder 104 that are transmitted in response to interrogations from external interrogation sources may be disregarded in favor of reply transmissions that are received in response to active interrogation of the transponder 104 by the transmitter 114.

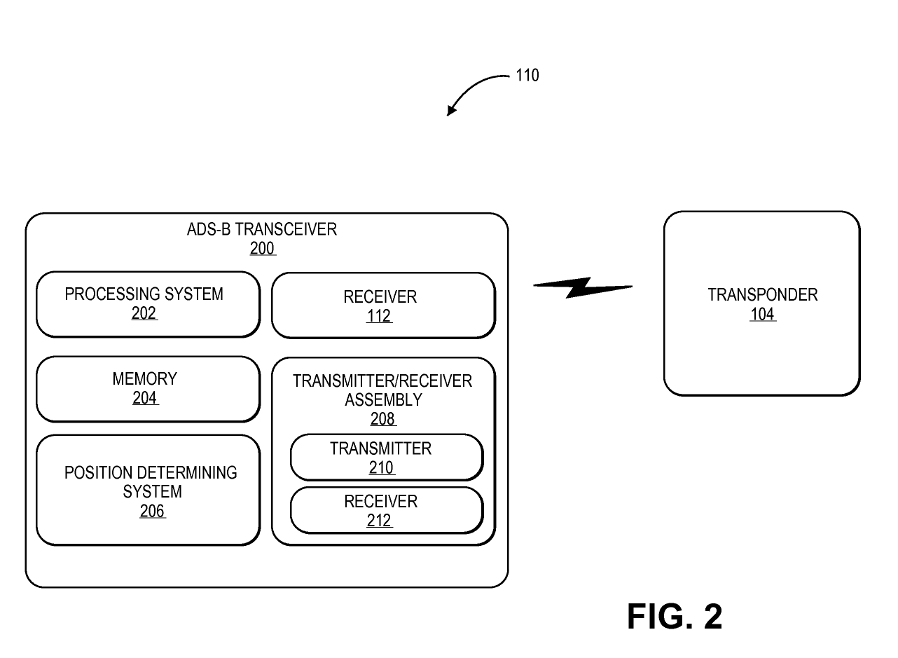

FIG. 2 illustrates an example ADS-B system 110 suitable for use by the aircraft 102 in the environment 100 of FIG. 1. In FIG. 2, the ADS-B system 110 is illustrated as being implemented as an ADS-B transceiver 200 suitable for installation within the aircraft 102. However, it is contemplated that other implementations of the ADS-B system 110 are possible.

As shown, the ADS-B transceiver 200 includes a processing system 202, a memory 204, a position determining system 206, a transmitter/receiver assembly 208, and the receiver 112 shown in FIG. 1. The processing system 202 provides processing functionality for the ADS-B transceiver 200 and may include any number of processors, micro-controllers, or other processing systems, and resident or external memory for storing data and other information received or generated by the ADS-B transceiver 200. The processing system 202 may execute one or more software programs or code segments which implement techniques described herein. The processing system 202 is not limited by the materials from which it is formed or the processing mechanisms employed therein, and as such, may be implemented via semiconductor(s) and/or transistors (e.g., electronic integrated circuits (ICs), programmable logic devices (PLDs), application-specific integrated circuits (ASICs)), and so forth.

The memory 204 is an example of tangible device-readable media that provides storage functionality to store various data associated with the operation of the ADS-B transceiver 200, such as the software programs and code segments mentioned above, or other data to instruct the processing system 202 and other elements of the ADS-B transceiver 200 to perform the steps described herein. Although a single memory 204 is shown, a wide variety of types and combinations of memory may be employed. The memory 204 may be integral with the processing system 202, stand-alone memory, or a combination of both. The memory may include, for example, removable and non-removable memory elements such as Random Access Memory (RAM), Read Only Memory (ROM), Flash memory, magnetic memory, optical memory, and so forth.

The position determining system 206 is configured to provide position-determining functionality for the ADS-B system 110. Position-determining functionality, for purposes of the following discussion, may relate to a variety of different navigation techniques and other techniques that may be supported by “knowing” one or more positions of the aircraft 102 (FIG. 1). For instance, position-determining functionality may be employed to provide location data, velocity data, acceleration data, rate of climb/descent data, heading data, and a variety of other navigation-related data to the processing system 202 for inclusion in reply transmissions broadcast by the transmitter/receiver assembly 208.

In implementations, the position-determining system 206 may comprise a receiver that is configured to receive signals from one or more position-transmitting sources. For example, the position-determining system 206 may be configured for use with a Global Navigation Satellite System (GNSS). In embodiments, the position-determining system 206 may be a Global Positioning System (GPS) receiver operable to receive navigational signals from GPS satellites and to calculate a location of the aircraft 102 as a function of the signals. Other exemplary position-determining systems include, but are not limited to, a Global Orbiting Navigation Satellite System (GLONASS), a Galileo navigation system, and/or other satellite or terrestrial navigation systems.

As illustrated in FIGS. 1 and 2, the position-determining system 206 may be integral with the ADS-B system 110. In other implementations, the position-determining system 206 may be configured as one or more separate avionics components that communicate position information with the ADS-B system 110 via a wired or wireless interface. A variety of configurations are possible.

The transmitter/receiver assembly 208 provides functionality to periodically broadcast information about the aircraft 102 and to receive periodic broadcasts containing such information from other aircraft and ground stations over an ADS-B data link. Accordingly, in FIG. 2, the transmitter/receiver assembly 208 is illustrated as including a transmitter 210 and a receiver 212. However, other configurations (e.g., a transceiver, multiple transmitters and/or receivers, etc.) are possible. In various embodiments, the transmitter/receiver assembly 208 may employ any of several different data link technologies, including but not limited to: Mode-S Extended Squitter (1090 ES), Universal Access Transceiver (978 MHz UAT), and VHF data link (VDL Mode 4).

The receiver 112, which is configured for passive reception, provides functionality to receive reply transmissions from the transponder 104 of the aircraft 102 (FIG. 1) that are transmitted in response to interrogation of the transponder 104 by an interrogation source. As noted, in one or more embodiments, the transponder 104 may comprise a Mode A/C or Mode S radar transponder. In such embodiments, the transponder 104 may be configured to detect interrogations transmitted at a frequency of 1030 MHz by ground stations or other active traffic detection equipped aircraft (e.g., air traffic control ground station 106 or aircraft 108 of FIG. 1). When an interrogation is detected, the transponder 104 transmits a 1090 MHz Mode A, Mode C, or a Mode S reply transmission. Accordingly, in such implementations, the receiver 112 may comprise a 1090 MHz receiver configured to receive the 1090 MHz Mode A, Mode C, or Mode S reply transmissions transmitted by the radar transponder.

Information that may be used by the ADS-B system 110, such as the assigned Mode 3/A “squawk” code for the aircraft 102, the IDENT indication for the aircraft 102, the aircraft's altitude, and the like, may then be extracted from the received reply transmission by the processing system 202 for broadcast by transmitter/receiver assembly 208 of the ADS-B system 110 over the ADS-B data link. In this manner, information utilized by an ADS-B system 110 installed within the aircraft 102 may be acquired without the installation of ADS-B dedicated flight crew controls and/or a wired data interface to the transponder 104 or other avionics in the aircraft 102 such as the transmitter 114.

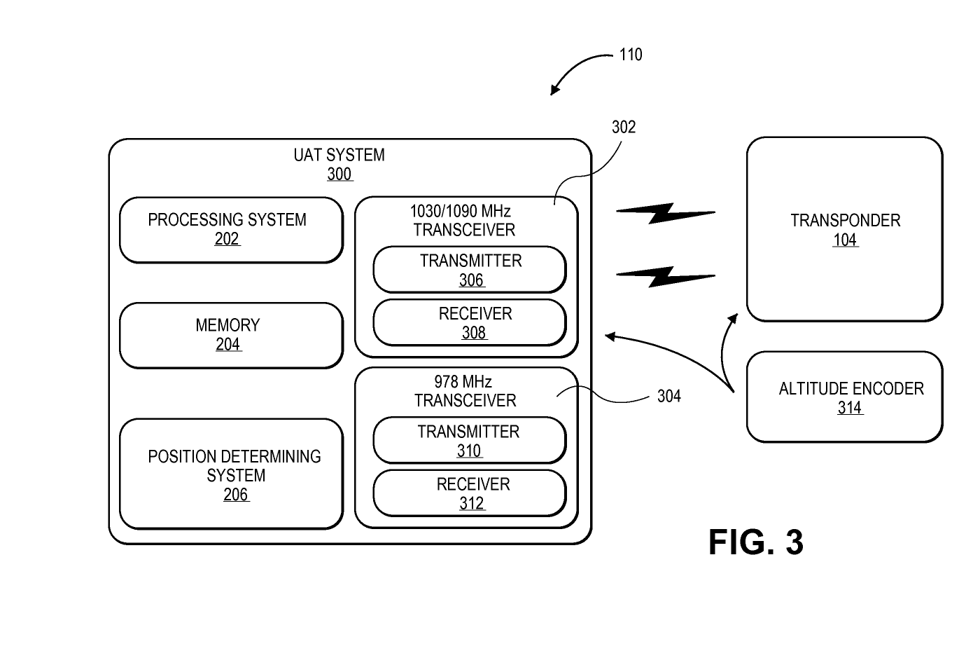

In FIG. 3, the ADS-B system 110 is illustrated as comprising a multi-mode UAT system 300 that is configured to self-synchronize its data with the aircraft's transponder 104 via system interrogations of the transponder 104. In embodiments, the ADS-B system 110 may comprise a UAT that may make use of multi-mode/multi channel radio transceivers. However, in other embodiments, the ADS-B system 110 may employ two or more UAT systems 300 each equipped with separate receivers that form ADS-B system 110.

The UAT system 300 employs a processing system 202, memory 204, and position determination system 206, which function as described in the discussion of FIG. 2. In the illustrated embodiment, UAT system 300 includes a full duplex 1030/1090 MHz transceiver assembly 302 and a 978 MHz transceiver assembly 304. The 1030/1090 MHz transceiver assembly 302 furnishes full duplex capability to communicate with the aircraft's transponder 104 via a 1030 MHz transmitter 306 for interrogations and a 1090 MHz receiver 308 for reception of transponder replies. The 978 MHz transceiver assembly 304 may be a UAT transceiver that includes a 978 MHz transmitter 310 and 978 MHz receiver 312.

During normal operation of the aircraft, the transponder 104 may receive a sufficient number of 1030 MHz interrogations from external interrogation sources (e.g., ground stations 106, other aircraft 108, and so forth (see FIG. 1)), and thus transmit a sufficient number of reply transmissions to render active interrogation of the transponder 104 by the 1030 MHz transmitter 306 unnecessary. Thus, the integrated 1030 MHz transmitter 306 for transponder interrogations may not be employed under such circumstances. However, when the UAT system 300 employs passive reception of transponder replies, a dedicated 1090 MHz receiver 308 may be provided to prevent reception of randomly occurring reply transmissions from being missed by the system 300.

In instances where a 1030 MHz transmitter 306 and active interrogation are employed, reply transmissions from the transponder 104 that are transmitted in response to interrogations from external interrogation sources (e.g., ground stations 106, other aircraft 108, and so forth (FIG. 1)) may be received by the 1090 MHz receiver 308 in addition to reply transmissions from the transponder 104 that are transmitted in response to interrogation by the 1030 MHz transmitter 306. However, it is contemplated that in some instances, these reply transmissions may be disregarded (e.g., in favor of reply transmissions that are received in response to active interrogation of the transponder 104 by the 1030 MHz transmitter 306).

In both passive reception and active interrogation modes, the UAT system 300 may include functionality to distinguish the reply transmissions by the aircraft's transponder 104 from reply transmissions received from other aircraft in the vicinity, which may also be responding (e.g., local traffic). Further, because pulse response message types used by transponders 104 are not marked, the UAT system 300 may include functionality to determine when the reply transmissions from the transponder 104 contain Mode A or Mode C data. For instance, the UAT system 300 may include functionality to measure the power levels of received reply transmissions. A determination can then be made, based on the power level of individual received reply transmission, whether the reply transmission originated from the aircraft's transponder 104 or the transponder of other aircraft in proximity to the aircraft 102 (e.g., aircraft 108 of FIG. 1). For example, the UAT system 300 may include functionality to determine when the power level of a received reply transmission exceeds a threshold power level, and is thus a reply transmission of the transponder, or is below a threshold power level, and is thus a reply transmission transmitted from another aircraft. Similarly, the UAT system 300 can store a signature of the power level of the transponder 104 of the aircraft 102 (e.g., in memory 204) to further prevent accidental use of data from transponder replies of adjacent traffic (e.g., aircraft 108 of FIG. 1).

The ADS-B system 110, when utilizing UAT (e.g., UAT system 300), and the transponder 104, when implemented as a traditional Mode A, Mode C, or Mode S transponder 104, may employ common altitude source data. In FIG. 3, the altitude source data is illustrated as being provided by an altitude encoder 314. However, it is contemplated that altitude source data can also be furnished by other compatible sources such as an encoding altimeter, an air data computer, and so forth. Using common altitude source data, the UAT system 300 may differentiate Mode A and Mode C replies, since the Mode C replies correspond directly with the aircraft's altitude source data (e.g., as provided by altitude encoder 314). The alternate code can be determined to be an appropriate Mode 3/A code and used to populate the ADS-B system 110 data fields.

Dissemination of data is simplified in implementations that incorporate the 1030 MHz transmitter 306 since the immediate response of the transponder 104 is known to be the Mode 3/A code or altitude information based on the type of interrogation sent. Since there is a relatively short time delay between the interrogation and the reply transmission, the reception window for a reply transmission may be narrowed to eliminate unwanted replies, and/or the integration power level may be reduced so that the minimum threshold of any adjacent aircraft transponders is not met and these transponders will not respond to the interrogations sent by the transmitter 306.

The UAT data link incorporates specifically defined guard bands that make it uniquely suited for multiplexing with little or no risk of losing information sent or received over the data link. In a multi-mode/multi channel implementation, the transmitter and the receiver may be shared between 978 MHz/1030 MHz and 978 MHz/1090 MHz, respectively, or any combination of multi-mode/multi channel and dedicated transceivers can be incorporated. Three, six millisecond (6 ms) guard bands provide time to switch modes and frequencies, interrogate the aircraft's transponder 104, receive the Mode 3/A and SPI status information, and return to normal UAT operation. Incorporation of randomly timing the 1030 MHz interrogation pulses helps ensure the spectral power distribution in the radar transponder spectrum.

Generally, functions described herein can be implemented using software, firmware, hardware (e.g., fixed logic circuitry), manual processing, or a combination of these implementations. The term “functionality” as used herein generally represents software, firmware, hardware or a combination thereof. In the case of a software implementation, for instance, functionality may refer to executable instructions that perform specified tasks when executed on a processor, such as a processor of processing system 202 of the ADS-B transceiver 200 of FIG. 2. The program code can be stored in one or more device readable media, an example of which is the memory 204 of the ADS-B system 110 of FIG. 2 or FIG. 3.

Example Procedures

The following discussion describes procedures that allow information to be acquired by an ADS-B system without the installation of ADS-B dedicated flight crew controls or wired data interfaces in the aircraft. Aspects of procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, or the ADS-B systems 110 of FIG. 2 or FIG. 3.

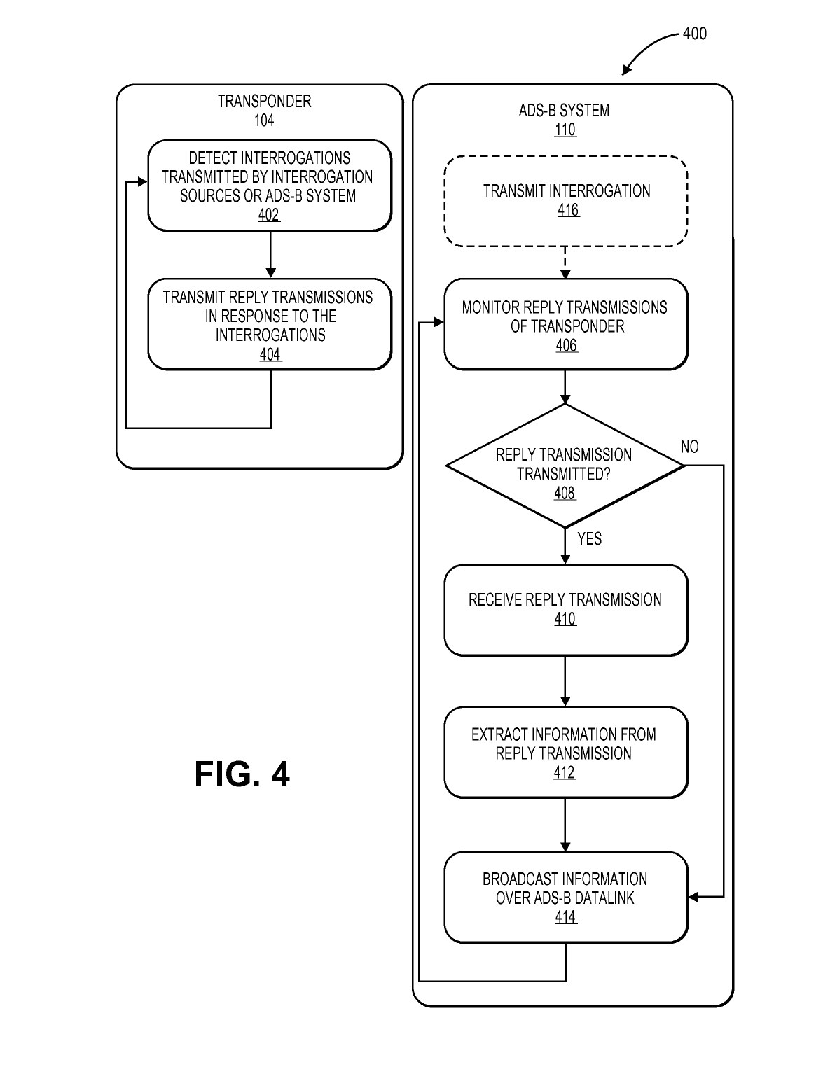

FIG. 4 depicts a procedure 400 in an example implementation in which information is acquired by an ADS-B system 110 of an aircraft, wherein the ADS-B system is equipped with a receiver configured to receive reply transmissions from a transponder of the aircraft. As illustrated, the ADS-B system 110 may employ passive reception or active interrogation techniques to acquire information from the transponder 104 of the aircraft in which the ADS-B system 110 is installed. Where passive reception of transponder reply transmissions is employed, the transponder 104 detects periodic interrogations transmitted by an interrogation source (Block 402). For example, in implementations where the transponder 104 comprises a radar transponder, the transponder 104 may detect interrogations transmitted at a frequency of 1030 MHz by ground stations or other active traffic detection equipped aircraft (e.g., air traffic control ground station 106 or aircraft 108 of FIG. 1). The transponder 104 transmits reply transmissions in response to the interrogations (Block 404). For example, the radar transponder may transmit a 1090 MHz Mode A, Mode C, or a Mode S reply transmission as described above in the discussion of FIG. 1.

The ADS-B system 110 monitors the reply transmissions transmitted by the transponder 104 (Block 406). When a reply transmission is transmitted by the transponder (“YES” at Decision Block 408), it is received by the ADS-B system 110 (Block 410) using a receiver associated with the system 110 (e.g., receiver 112 of FIGS. 1 and 2).

Information suitable for use by the ADS-B system 110 is then extracted from the received reply transmission (Block 412). For instance, in implementations where the transponder 104 comprises a radar transponder configured to transmit Mode A, Mode C, or Mode S reply transmissions, the ADS-B system may extract data such as an assigned Mode 3/A “squawk” code for the aircraft, the IDENT indication for the aircraft, the aircraft's altitude, and the like. In one or more embodiments, the extracted information may be configured to be included in the broadcast by the ADS-B system 110 over the ADS-B data link. For instance, the extracted information may be formatted so that the information is compatible with ADS-B.

The extracted information is then included in the data broadcast over the ADS-B data link by the ADS-B system 110 (Block 414). For instance, in one or more embodiments, data broadcast by the ADS-B system 110 may be stored in memory 204 of the ADS-B transceiver 200 (FIG. 2) or UAT system 300 (FIG. 3). The extracted information may be used to periodically update this stored data. The stored ADS-B data, which includes the extracted information, may then be included in the data broadcast over the ADS-B data link by the transmitter/receiver assembly 208. For example, data stored in memory 204 of the ADS-B system 110 may include the aircraft's altitude. During flight, the aircraft's altitude may change, causing new altitude information to become available from reply transmissions transmitted by the transponder 104. This new altitude information is extracted from the reply transmissions and used to update the altitude data stored in memory 204 for broadcast over the ADS-B data link.

As noted, the ADS-B system 110 may employ passive reception of transponder reply transmissions. In such implementations, the receiver 112 is configured to receive reply transmissions of the transponder 104 that are transmitted in response to interrogation of the transponder 104 by an interrogation source external to the aircraft 102 (e.g., a ground station 106, another aircraft 108, and so forth). In some embodiments, the periodic broadcast rate of the ADS-B system 110 (e.g., of the transmitter/receiver assembly 208 of the ADS-B transceiver 200 of FIG. 2 or the UAT system 300 of FIG. 3) may differ from the rate at which the transponder 104 is interrogated and/or reply transmissions are transmitted. For instance, ground-based radar interrogations are generally transmitted at six (6) to twelve (12) second intervals. Accordingly, transponder reply transmissions may be transmitted by the transponder 104 at a corresponding rate. The ADS-B system 110, on the other hand, may broadcast data over the ADS-B data link at a rate of one (1) broadcast per second or greater. Consequently, in the procedure 400 shown in FIG. 3, the ADS-B data may be broadcast over the ADS-B data link (Block 414) without first being updated with information extracted from the reply transmission of the transponder 104 when a reply transmission has not been transmitted (“NO” at Decision Block 408). In this manner, the ADS-B system 110 may transmit one or more broadcasts over the ADS-B data link between receipts of successive reply transmissions from the transponder 104.

Conversely, it is contemplated that, in one or more embodiments, the transponder 104 may transmit one or more reply transmissions between broadcasts by the ADS-B system 110. In such embodiments, data broadcast over the ADS-B data link may be updated with information extracted from the most recent reply transmission received from the transponder 104. However, it is also possible that information extracted from older reply transmissions of the transponder 104 received between ADS-B transceiver broadcasts may be used to update the ADS-B data instead of information extracted from the most recent reply transmission, or that information extracted from two or more reply transmissions may be combined (e.g., altitude information extracted from successive reply transmissions received from the transponder 104 may be averaged).

The ADS-B system 110 may also employ active wireless interrogation of the transponder to cause the transponder to broadcast reply transmissions. In such implementations, the ADS-B system 110 may transmit interrogations to the transponder 104 to cause the transponder 104 to transmit a reply transmission. For example, as noted, the ADS-B system 110 may further include a transmitter 114(306) configured to transmit interrogations to the transponder 104 to cause the transponder 104 to transmit a reply transmission that may be received by the receiver 112(308).

The ADS-B system 110 monitors the reply transmissions transmitted by the transponder 104 in response to the interrogations (Block 406). When the reply transmission is transmitted by the transponder (“YES” at Decision Block 408), it is received by the ADS-B system 110 (Block 410) using a receiver associated with the system 110 (e.g., receiver 112 of FIG. 1 and FIG. 2 or receiver 308 of FIG. 3). Information suitable for use by the ADS-B system 110 is then extracted from the received reply transmission (Block 412) and included in the data broadcast over the ADS-B data link by the ADS-B system 110 (Block 414) as described above.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A transceiver system configured to be mounted in an aircraft, the system comprising:
a transponder operable to broadcast a transmission that contains information that describes at least one of the identity and a status of the aircraft;
a receiver operable to periodically receive the transmission from the transponder of the aircraft; and
a processing system operable to:
determine if the received transmission originated from the aircraft, and
if the received transmission originated from the aircraft, cause the information from the received transmission to be extracted for use in a broadcast over an ADS-B datalink.

2. The transceiver system of claim 1, wherein the processing system is operable to determine if the received transmission originated from the aircraft and not other aircraft by using a power level associated with the transponder of the aircraft.

3. The transceiver system of claim 2, wherein the receiver is further operable to measure a power level associated with the received transmission and the processing system is operable to compare the measured power level with the power level associated with the transponder of the aircraft.

4. The transceiver system of claim 2, wherein the processing system further includes a memory operable to store a signature of the power level associated with the transponder of the aircraft.

5. The transceiver system of claim 1, wherein the processing system includes a memory and is further operable to store a type of the transmission broadcast by the transponder and use the stored transmission type to determine if the received transmission originated from the aircraft.

6. The transceiver system of claim 1, wherein the processing system includes a memory and is further operable to store a time of the transmission broadcast by the transponder and use the stored time to determine if the received transmission originated from the aircraft.

7. The transceiver system of claim 1, wherein the transponder comprises a radar transponder.

8. The transceiver system of claim 1, wherein the receiver comprises a 1090 MHz receiver configured to receive a Mode A, Mode C, or Mode S reply transmission.

9. The transceiver system of claim 8, wherein the information extracted from the transmission comprises at least one of an assigned Mode 3/A “squawk” code for the aircraft, an IDENT indication for the aircraft, or an altitude of the aircraft.

10. The transceiver system of claim 9, further including an altitude source coupled with the transponder and the processing system and operable to provide altitude data thereto, wherein the processing system is operable to differentiate received Mode A reply transmissions from received Mode C reply transmissions using the altitude data.

11. The transceiver system of claim 10, wherein the altitude source includes an altitude encoder.

12. The transceiver system of claim 10, wherein the processing system is operable to determine the Mode 3/A “squawk” code by differentiating received Mode A reply transmissions from received Mode C reply transmissions using the altitude data.

13. The transceiver system of claim 1, further including a global navigation satellite system receiver operable to determine a position of the aircraft.

14. The transceiver system of claim 1, further including a transmitter operable to broadcast an interrogation for reception by the transponder, wherein the power level used by the transmitter to broadcast the interrogation is reduced to limit reception of the interrogation by other aircraft.

15. A method comprising:
(a) broadcasting a transmission from a transponder on an aircraft, the transmission containing information that describes at least one of the identity and a status of the aircraft;
(b) periodically receiving, with a receiver on the aircraft, the transmission from the transponder on the aircraft;
(c) determining, with a processing system on the aircraft, that the received transmission originated from the aircraft; and
(d) if the received transmission originated from the aircraft, using the processing system to cause the information from the received transmission to be extracted for use in a broadcast over an ADS-B datalink.

16. The method of claim 15, wherein (c) includes using a power level associated with the transponder of the aircraft to determine if the received transmission originated from the aircraft and not the other aircraft.

17. The method of claim 15, further including measuring a power level associated with the received transmission, wherein (c) includes comparing the measured power level with the power level associated with the transponder of the aircraft to determine if the received transmission originated from the aircraft and not other aircraft.

18. The method of claim 15, further including storing a type of the transmission broadcast by the transponder in a memory associated with the processing system and using the stored transmission type to determine if the received transmission originated from the aircraft.

19. The method of claim 15, wherein the received transmission is at least one of a Mode A, Mode C, or Mode S reply transmission and the information extracted from the transmission comprises at least one of an assigned Mode 3/A “squawk” code for the aircraft, an IDENT indication for the aircraft, or an altitude of the aircraft.

20. The method of claim 15, further including: (e) broadcasting an interrogation for reception by the transponder, wherein the power level used by the transmitter to broadcast the interrogation is reduced to limit reception of the interrogation by other aircraft.
